(19) United States
(12) Patent Application Publication
(10) Pub. No.: US 2008/0059267 A1
(43) Pub. Date: Mar. 6, 2008

(54) Employee setup management system

(75) Inventors: Darin E. Hamilton, Creve Coeur, IL (US); Jason M. Cassidy, East Peoria, IL (US); Richard W. Shanks, Peoria, IL (US); Camden M. Bucey, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/512,277

(22) Filed: Aug. 30, 2006

(51) Int. Cl. G06F 9/46

(52) U.S. Cl. 705/8

(57) ABSTRACT

A computer-readable medium is provided, which may have stored thereon instructions for tracking tasks related to a method for an employee setup. The method may include collecting input related to setup of an employee including one or more task requests for performance of one or more tasks involved in employee setup. The method may also include directing information related to the one or more task requests to task performers. In addition, the method may include collecting input from the task performers related to the progress of completion of the requested tasks. Further, the method may include displaying information related to the progress of completion of the requested tasks, wherein the displayed information indicates one of a plurality of incremental levels of completion.

### TECHNICAL FIELD

The present disclosure is directed to an employee setup management system and, more particularly, to an employee setup management system including one or more progress indicator features.

### BACKGROUND

Anytime an employee is newly hired or transferred from one division to another within a company (for purposes of discussion, both transfers and new hires will be referred to as employee “moves”), there are numerous tasks that must be coordinated and performed in order to situate the employee and enable them to begin working. For purposes of this disclosure, the performance of these tasks shall be referred to as employee “setup.” For example, basic resources are often required at the employee's new office location, such as office furniture, computer, telephone, etc. In addition, certain accounts and/or services often need to be set up for the employee, such as security authorizations/access keys and/or codes, ID badges, computer accounts, email, telephone, cell phone, etc. Further, certain training may be appropriate or necessary for the employee. Such training may even be required by law. Also, some employees may have special needs, such as handicap access, TTL (phone accommodation for the hearing impaired), etc.

Historically, employee setup has been managed “by hand.” For example, paper checklists for various types of employee setup would be passed from person to person as they accomplished the tasks for which they were responsible. While this type of system may eventually insure that all the appropriate tasks are completed, such a system may be inefficient, resulting in significant delays that, in some cases, may lead to an employee not having all the appropriate resources available to them at the time they begin working in their new capacity. For example, an employee may not have their computer up and running when they begin work. Not only is the progress of employee setup difficult to monitor (i.e., the paper checklist must be tracked down and/or each person responsible for the tasks on the checklist must be contacted), but due to the sequential nature of handing the checklist from person to person, failure of one person to complete their task in a timely manner may unduly delay the rest of the persons on the list from completing theirs.

Electronic systems have been developed to facilitate organization, management, tracking, etc. of various tasks, duties, and/or roles of persons involved in situating an employee at a new office location. For example, U.S. Pat. No. 6,678,714, issued to Olapurath et al., (“the '714 patent) discloses a computer-implemented task management system. The system disclosed in the '714 patent may be configured to accept input from task requesters and deliver the requests to task performers. The system of the '714 patent may be configured to display information related to the progress of the task performers to various individuals with access to the system. However, the system of the '714 patent is not configured to display information that indicates one of a plurality of incremental levels of completion. Those tracking the progress of employee setup could benefit from knowledge regarding the level of progress of the employee setup beyond simply a “complete” or “not complete” classification. For example, in some instances, it may be desirable to monitor the percent completion of various tasks or of the entire employee setup process for one or more employees.

The present disclosure is directed to solving one or more of the problems discussed above.

### SUMMARY OF THE INVENTION

In one aspect, the present disclosure is directed to a computer-readable medium having stored thereon instructions for tracking tasks related to a method for an employee setup. The method may include collecting input related to setup of an employee including one or more task requests for performance of one or more tasks involved in employee setup. The method may also include directing information related to the one or more task requests to task performers. In addition, the method may include collecting input from the task performers related to the progress of completion of the requested tasks. Further, the method may include displaying information related to the progress of completion of the requested tasks, wherein the displayed information indicates one of a plurality of incremental levels of completion.

In another aspect, the present disclosure is directed to a method for an employee setup. The method may include collecting input related to setup of an employee including one or more task requests for performance of one or more tasks involved in employee setup. The method may also include directing information related to the one or more task requests to task performers. In addition, the method may include collecting input from the task performers related to the progress of completion of the requested tasks. Further, the method may include displaying information related to the progress of completion of the requested tasks, wherein the displayed information indicates one of a plurality of incremental levels of completion.

In another aspect, the present disclosure is directed to a computer-readable medium having stored thereon instructions for tracking tasks related to a method for an employee setup. The method may include collecting input related to setup of an employee including one or more task requests for performance of one or more tasks involved in employee setup. The method may also include directing information related to the one or more task requests to task performers. In addition, the method may include collecting input from the task performers to thereby define subtasks involved in completing the requested tasks. Further, the method may include associating the subtasks with subsequent requests for the same tasks.

### BRIEF DESCRIPTION OF THE DRAWINGS

FIG. 1 is a diagrammatic illustration of an employee setup management system according to an exemplary disclosed embodiment.

FIG. 2 is a flow chart including functions that may be performed by an exemplary disclosed embodiment of the disclosed system.

FIG. 3 is an exemplary input interface consistent with certain disclosed embodiments of the employee setup management system

FIG. 4 is an exemplary status report as displayed by a display device according to an exemplary disclosed embodiment.

FIG. 5A is an alternative format of a status report according to an exemplary disclosed embodiment.

FIG. 5B is a further alternative format of a status report according to an exemplary disclosed embodiment.

FIG. 6 is an efficiency report as displayed by a display device according to an exemplary disclosed embodiment.

### DETAILED DESCRIPTION

Reference will now be made in detail to the drawings. Wherever possible, the same reference numbers will be used throughout the drawings to refer to the same or like parts.

For purposes of this disclosure, the term employee “setup” shall refer to the performance of tasks that are coordinated and performed in order to situate an employee and enable them to begin working. The term setup “scheme” shall refer to a group of such tasks, which are related to a particular type of employee setup, such as an employee transfer or setup of a newly hired employee. Other exemplary setup schemes may include arranging training for an employee, upgrading a computer, changing office locations, etc.

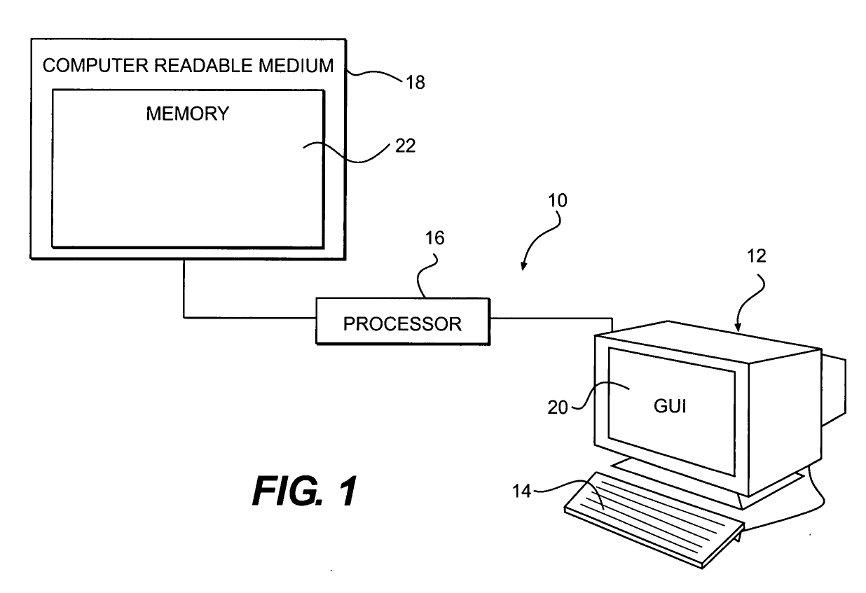

FIG. 1 illustrates an employee setup management system 10. System 10 may include a display device 12, an input device 14, a processor 16, and a computer-readable medium 18 operatively coupled to processor 16.

Display device 12 may include any type of display equipment configured to provide visual feedback regarding system 10 and its components and functions. Display device 12 may include any of a number of screen type displays, such as, for example, a cathode ray tube (CRT) as shown in FIG. 1, a liquid crystal display (LCD), a plasma screen, or the like. Display device 12 may be configured to display an input interface 20. Input interface 20 may be displayed in any format suitable for accepting data entry. Display device 12 may also provide other information regarding any other device and/or system associated with system 10. System 10 may be Internet-based and, as such, input interface 20 may be displayed by display device 12 as one or more web pages available on a local or global network.

Input device 14 may be configured to accept input related to setup of an employee including one or more task requests for performance of one or more tasks involved in employee setup. Input device 14 may include any type of devices suitable for inputting data and/or navigating through screens/menus that may be displayed by display device 12. For example, input device 14 may include a keyboard (as shown in FIG. 1), mouse, etc. In some embodiments, input device 14 may be at least partially integrated with display device 12. In such embodiments, display device 12 may include, for example, a touch screen.

Although system 10 is illustrated as including a desktop computer, wherein display device 12 includes a CRT monitor, system 10 may alternatively or additionally include a portable, and in some cases, handheld unit (not shown). Exemplary handheld units may include laptops, personal data assistants (PDAs), or other devices distinctly designed for use with system 10.

Processor 16 may be configured to process accepted setup information, and generate output therefrom. Computer-readable medium 18 may include any type of computer-readable medium including, for example, computer chips and secondary storage devices, including hard disks, floppy disks, optical media, CD-ROM, or other forms of RAM or ROM. Computer-readable medium 18 may include a memory 22 in which is stored instructions for stored thereon for performing a method for employee setup.

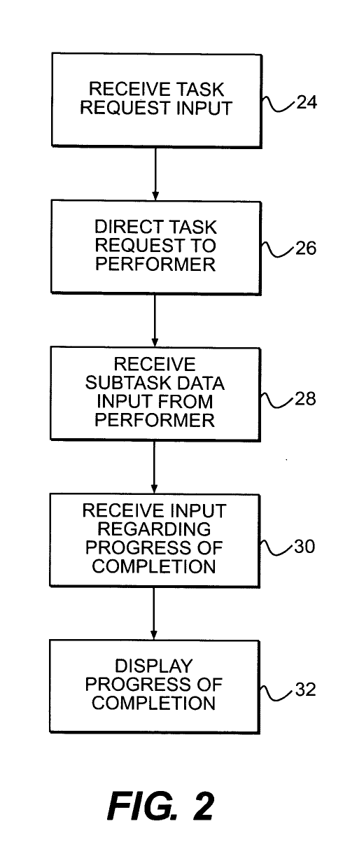

FIG. 2 is a flowchart illustrating an exemplary embodiment of such a method. As in the illustrated example, the method may include collecting input related to setup of an employee including one or more task requests for performance of one or more tasks involved in employee setup (Step 24). The method may also include directing the task request to task performers (Step 26).

Task performers (which may also be referred to as “stakeholders”) may include any persons and/or entities responsible for performing tasks related to employee setup. Exemplary task performers may include those responsible for ordering new office furniture, delivering and/or installing computers, creating security I.D. badges, adding or dropping the employee's name from various distribution lists, etc. Task performers may be employees of the company/entity requesting the employee setup. Alternatively or additionally, the task performers may be employees of a separate company/entity (e.g., a contractor). A contractor or contract worker may include someone who will do work for a company, perhaps at the company's facility, on a semi-permanent basis, but who is not an actual employee of the company. One example of a contractor task performer may include a graphics/signage company having a contract with the requesting company to produce nameplates for new employees' offices. A task request to make a nameplate may be directed to the graphics company as part of a “new-hire” setup scheme.

Task requests may be sent to task performers via any number of electronic communication means. For example, in some embodiments the task requests may be sent via email. Alternatively or additionally, the task requests may be stored within system 10 such that they may be viewable by individuals accessing system 10, such as the task requestor and/or task performer of each requested task, as well as supervisory/managerial individuals.

System 10 may be configured to classify not only individuals as task performers, but also additional individuals as backup task performers. In some embodiments some backup task performers may be permanently designated as a primary task performer in the event that the prior task performer is not longer available (e.g., they move on to another job). Alternatively or additionally, some backup task performers may be only temporarily designated as a primary task performer until a permanent replacement can be designated. In some embodiments, the unavailability of a primary task performer may be communicated to a task requestor, supervisor, etc., in order to prompt them to begin the process of finding a permanent replacement.

In addition, the method may include receiving subtask data input from one or more task performers (Step 28). Further, the method may include receiving input regarding progress of completion of one or more tasks, task groups, and/or setup schemes (Step 30). The method may also include displaying progress of completion in one or more different ways (Step 32). Additional details regarding these exemplary method steps are discussed below.

The collected input may be made, for example, using input device 14. Such input may be made by any person authorized to request tasks using system 10, such as, for example, a division supervisor, human resources employee, or any other such persons in a managerial and/or supervisory position. In some embodiments input may be made over a global or local network, for example, using a web-based (e.g., Internet-based) system. In such embodiments, input device 14 may be located at a location remote from computer-readable medium 18 and processor 12.

System 10 may be configured such that a task requestor, such as, for example, a division level supervisor, may initiate the employee setup using system 10. The supervisor may be able to choose from a variety of predetermined setup schemes. For example, the supervisor may be able to designate whether the employee requiring setup is a new hire, an internal transfer from another division, moving to a different office space within a division, etc. and, thereby select a setup scheme corresponding to the type of setup needed by the employee. For setups like transfers, where the person is already an employee of the company, system 10 may be configured to retrieve personal data about the employee from a company or division database. Such personal data may populate data fields in system 10 automatically upon retrieval of an employee's name or employee number in the database.

In addition, the system 10 may be customizable to create, modify, and/or organize tasks, task groups, and/or setup schemes. For example, if a particular division of a company establishes a new department, such as a shipping department, then system 10 could be used to create new, selectable setup schemes for employees to be setup in the new department, and to designate the tasks associated with the new setup scheme. Also, if a division starts a new program or policy, then a new task could be added to existing selectable setup schemes for employee setup in that division. An exemplary new program may include providing its employees with cell phones when they had not in the past. A task requestor or another person authorized to designate which tasks are involved in a particular setup scheme may modify the setup scheme for employees being setup in that division to include a task related to cell phone setup, such that the task performers that are responsible for ordering and/or setting up the cell phones are notified, whenever an employee is setup to work in that division, that there is an employee in need of having a cell phone setup. Customization of a setup scheme or other group of tasks may also be made with the same kind of input interface as selection of tasks or schemes. That is, customization may be made, for example, using menus, folders, and/or drag and drop input, wherein a user may drag an icon representing a task, group of tasks, or scheme into an area representing a bin or “to do list,” somewhat like an on-line shopping cart.

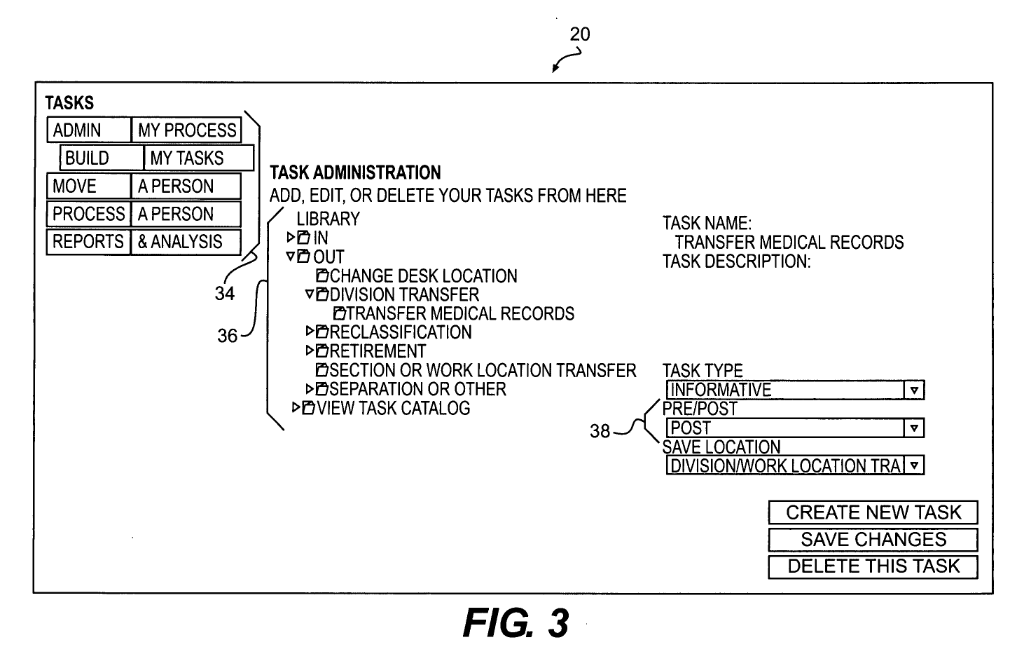

As shown in FIG. 3, input interface 20 may display a series of menus and/or folders from which a user may create, modify, and/or select tasks, task groups, and/or setup schemes, as well as access data relating to progress of a particular request or group of requests and/or timeliness/efficiency of a task performer and/or various groups of task performers (e.g., reports regarding timeliness/efficiency of a particular division). For example, a menu section 34 may allow a user to choose from these functions. Although, FIG. 3 shows several functions available for selection, these are intended to be exemplary, and other selectable functions may be provided. Once a menu option has been chosen, various tools and options may be available for each menu option. For example, as shown in FIG. 3, selection of the task administration menu choice will reveal a library 36 of folders, which organize the tasks, task groups, and/or setup schemes.

In addition to other types of classification and/or instructional details, tasks, task groups, and/or setup schemes may be designated for completion either prior to an employee starting work in their new workspace or after they start work in their new workspace. A selectable Pre/Post menu 38 may enable certain tasks, such as furniture delivery, to be designated as “pre,” whereas other tasks, such as training, may be designated as “post.” However, in some cases, tasks designated as “post” may be completed prior to an employee starting work in their new workspace. Similarly, certain tasks designated as “pre” may be performed after the employee starts work.

Also, two or more tasks and/or subtasks may be designated to be performed sequentially. For example, in some embodiments, it may be desirable to insure that there is a desk in a workspace before a computer is delivered and/or installed. In such a case, system 10 may be configured to notify task performers at an appropriate time to perform their respective requested task at an appropriate time. In some cases, a task request for computer installation may be withheld until the desk delivery task has been completed. That is, once the desk delivery task performer has indicated in system 10 that the desk delivery task has been completed, system 10 may automatically send the task request for computer delivery/installation. Alternatively, requests for both tasks may be delivered at the time of the initial setup request, and a notification may also be sent to the computer delivery/installation task performer (as well as other interested parties, e.g., a supervisor) to alert them that the desk installation has been completed and that computer delivery/installation may be performed.

This capability of designating two or more tasks to be performed sequentially may enable users of system 10 to encourage or require employees to comply with various company rules and/or policies. One particular use may be to promote safety and/or security. For example, system 10 may prevent completion of or withhold requests for setting up a new employee's security badge access to a facility or portion thereof until a may be prevented or otherwise withheld until the employee has completed certain training. Such training may include, for example, safety training. Without having a security badge to swipe in a card reader to enter the facility, the employee would have to stop and sign in at the security desk/office each time they enter the building. In order to avoid this daily inconvenience, an employee must first complete a safety training course.

System 10 may be configured to send notifications and/or reminders to task performers if task requests for which they are responsible remain uncompleted. Such reminders may be sent at predetermined times as a target deadline approaches and/or after the deadline has passed.

In some embodiments, the method may include collecting input from the task performers to thereby define subtasks involved in completing the requested tasks (See FIG. 2, Step 28). The method may further include associating the subtasks with subsequent requests for the same tasks. For example, when a task performer receives a task request for providing an employee with a cell phone, the task performer may customize system 10 by inputting the various subtasks that are involved in providing a cell phone to an employee. Exemplary subtasks for such a task may include calling a cell phone supplier to order the phone and any related hardware, calling a cell phone service provider to set up a new account for the employee, and ordering the delivery of the actual phone to the employee. These subtasks may be entered and stored such that each time a request for providing a cell phone is forwarded to the task performer, system 10 will prompt the task performer to complete the associated list of subtasks. Such customization may be specific to a given task performer or group of task performers (e.g., a shipping department, information technology department, etc.). Further, such customization may be specific to a given work facility, location, etc., or any other categorized group of task performers.

The method may also include collecting input from the task performers related to the progress of completion of the requested tasks (See FIG. 2, Step 30). For example, system 10 may include an electronic checklist feature. The task performers may make such input using input device 14. However, since system 10 may be embodied in a network, as discussed above, task requesters and task performers may each have their own computer workstations from which they access system 10. Therefore, each may have their own input device, which may be the same type as input device 14 or may include other types.

System 10 may also be configured to provide an indication of the level of completion of groups of tasks or of the employee setup scheme as a whole. System 10 may be configured to numerically and/or graphically display the progress of individual tasks, groups of tasks, and/or the setup scheme as a whole (See FIG. 2, Step 32). Accordingly, computer-readable medium 18 may contain instructions for displaying information related to the progress of completion of one or more requested tasks, groups of tasks, and/or the setup scheme as a whole.

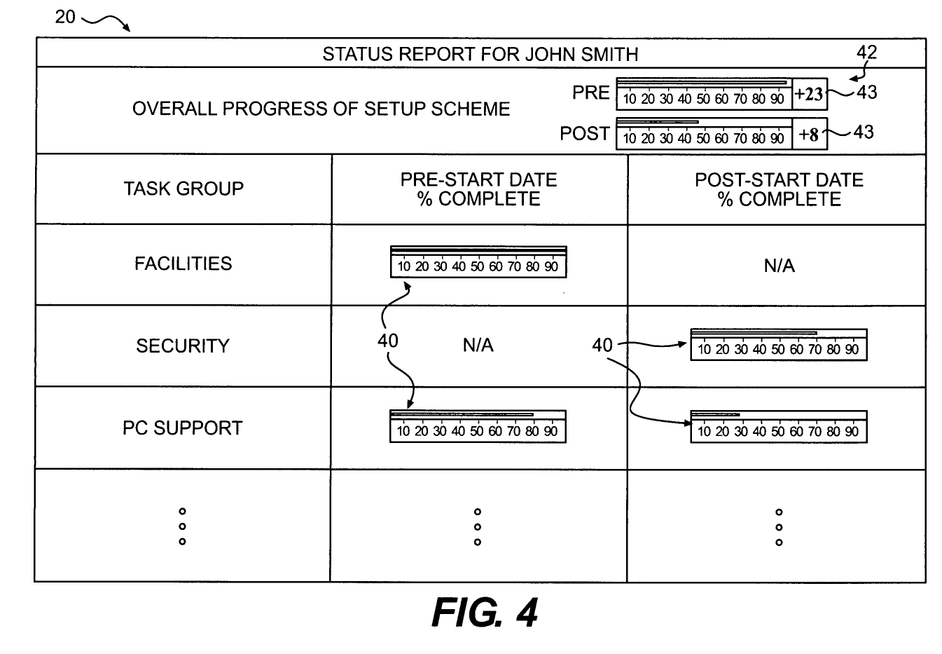

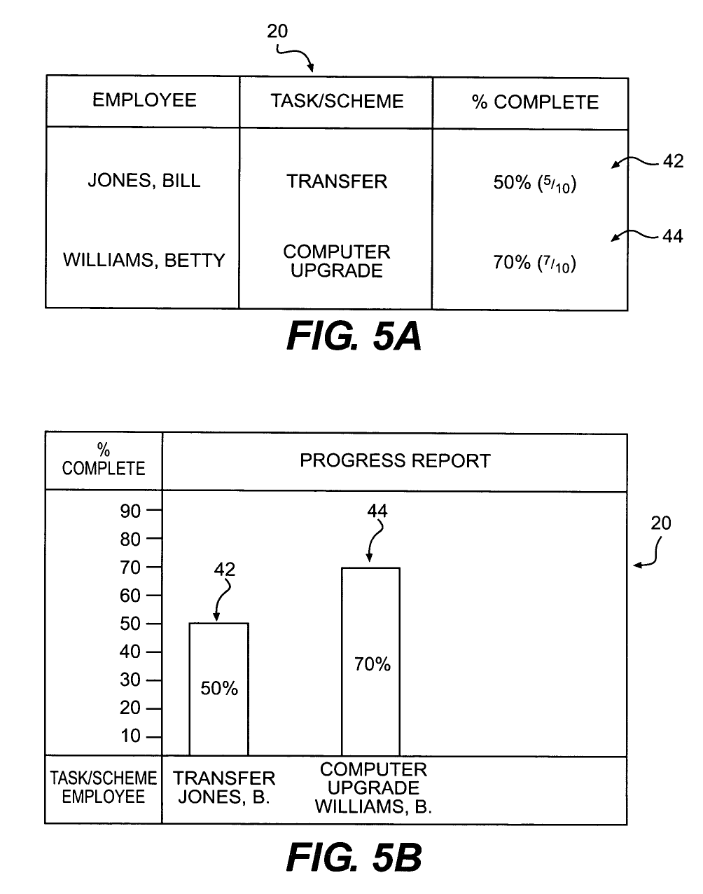

In some embodiments, the displayed progress information may indicate one of a plurality of incremental levels of completion. For example, as illustrated in FIG. 4, display device 12 may be configured to display a task progress indicator (See FIG. 5A and FIG. 5B) or a task group progress indicator 40 and/or a setup scheme progress indicator 42, which may include a numerical value, chart, graph, etc., indicating a level of completion of one or more tasks. It should be understood that the graphical depiction of a data displays in FIGS. 4, 5A, and 5B are intended to be exemplary only and that the layout, organization, and various other details of the graphics in FIGS. 4, 5A, and/or 5B could be displayed in any suitable way.

Beyond simply indicating whether or not the task has been completed, display device 12 may indicate incremental levels of completion, such as, for example, percentages of completion, as shown in FIG. 4. Incremental levels of completion may include any graphical and/or numerical levels that may provide a quantitative and/or qualitative representation of the progress of completion of the tasks. For example, incremental levels of completion may be displayed with task progress indicators, which, as shown in FIG. 4 may include graduated bar graphs, as well as numerical values 43 indicating the amount of time remaining until a predetermined deadline. Alternatively, or additionally, a task progress indicator 44 (and/or task group progress indicator 40 or setup scheme progress indicator 42) may include a percentage value (e.g., “50% complete”) as illustrated in FIG. 5A, a ratio (e.g., “9/10 complete”) as also illustrated in FIG. 5A, a bar graph as illustrated in FIG. 5B, a sliding scale type graphic, a dial/gauge graphic, a pie chart, a line graph, or any other alpha-numerical and/or graphical representation of incremental levels of task, task group, and/or setup scheme completion. The bar graphs in FIGS. 4, 5A, and 5B may be displayed with varying color depending on the level of completion being illustrated. For example, a bar illustrating less than 33% completion may be shown in red, a bar illustrating between 33-67% completion may be shown in yellow, and a bar illustrating from 67-100% completion may be shown in green.

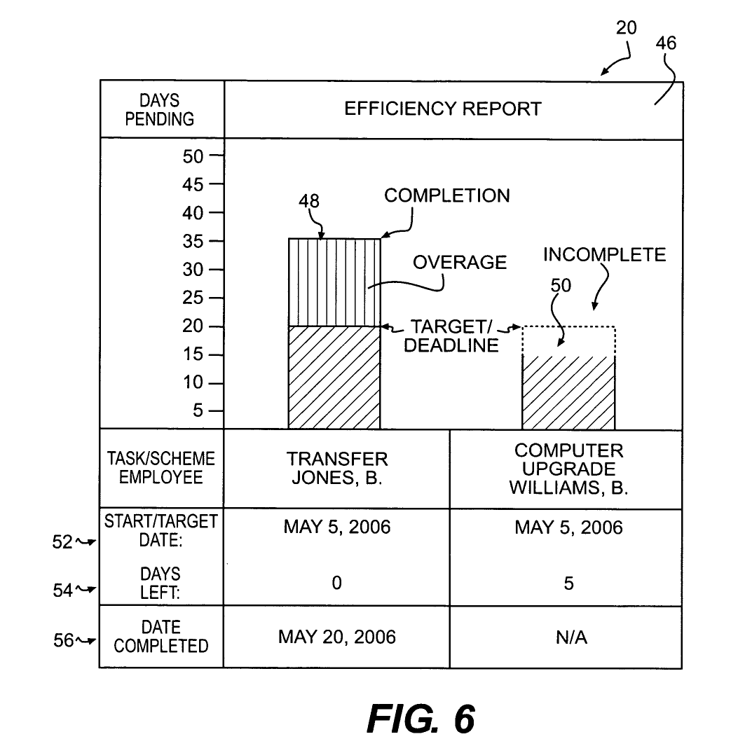

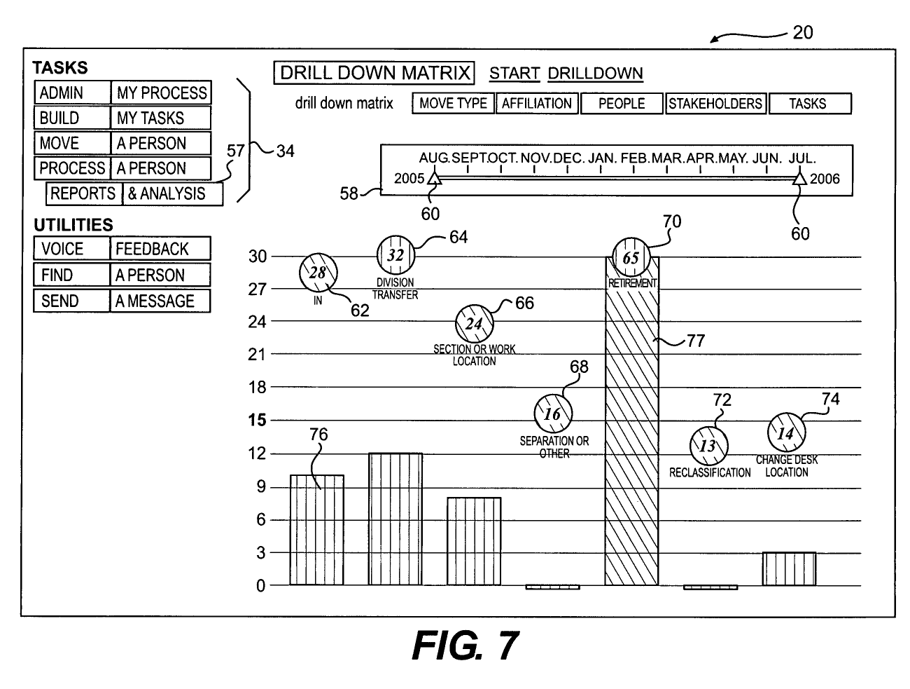

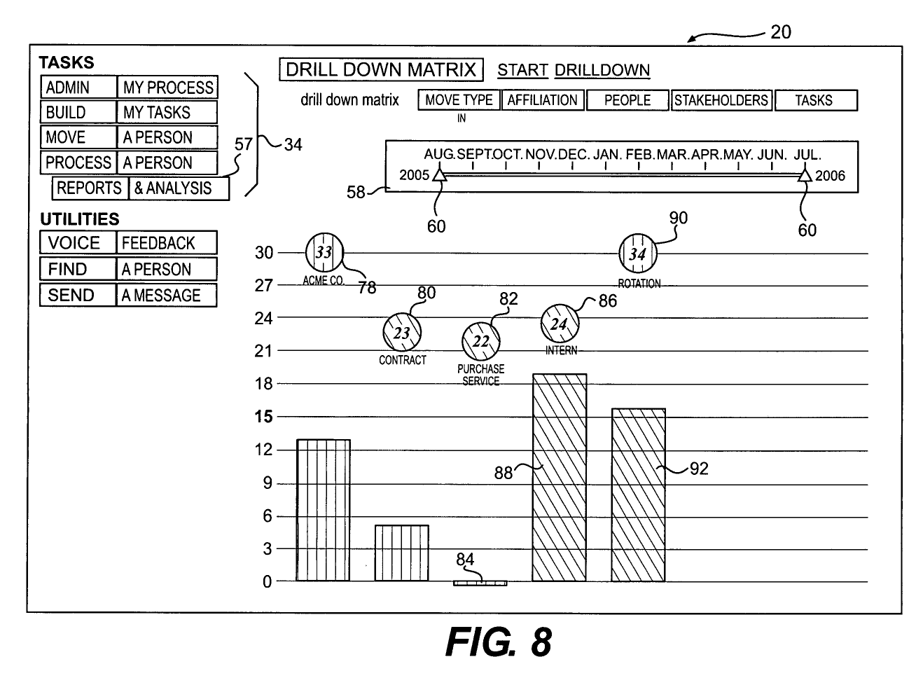

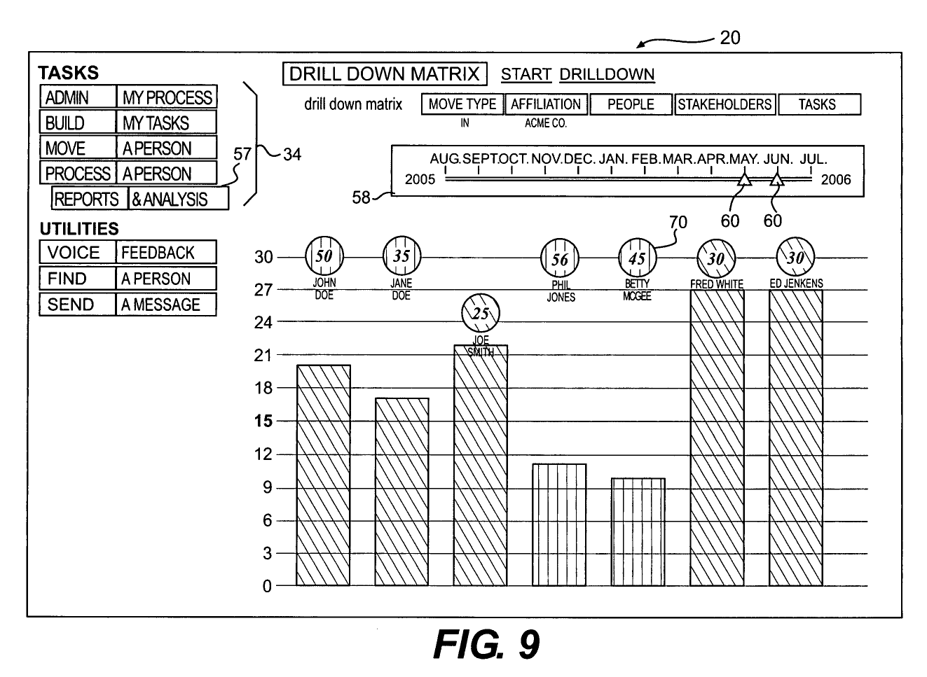

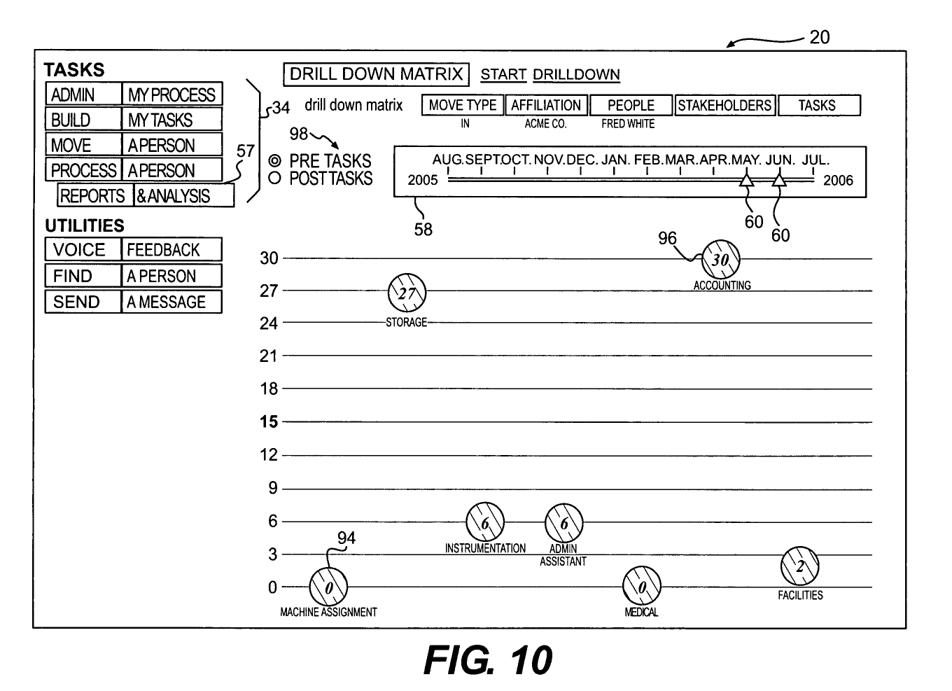

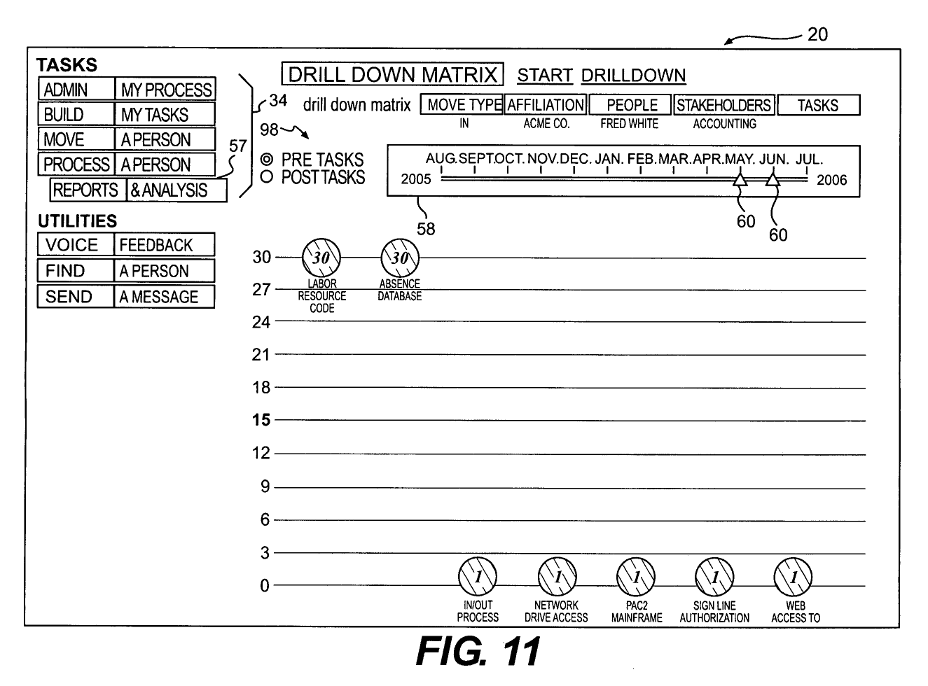

System 10 may be configured to display, using display device 12, data relating to the timeliness/efficiency of task and/or scheme completion (See FIG. 2, Step 32). For example, as illustrated in FIG. 6, the number of days it takes to complete a requested task or scheme may be numerically and/or graphically displayed, for example, in an efficiency report 46. The time to completion may also be compared to a target time for completion and/or a deadline. In some embodiments, efficiency report 46 may indicate how much longer it took to complete the task than was desired (this may be referred to as “overage,” as indicated in FIG. 6). Such an efficiency report may be used to analyze both tasks that have been completed and tasks that have not been completed. For example, a graphic for a completed task may include a closed-top bar graph 48, whereas a graphic for an incomplete task may include an open-top bar graph 50. Such a designation is intended to be exemplary only, and any graphical and/or alpha-numerical indication of whether a task has been completed may be utilized. Alternatively or additionally, display device 12 may display a completion date and/or the number of days that it took to complete a task or scheme. For a new employee scheduled to start work on a particular start date, a start/target date graphic 52 and/or a count down graphic 54, as well as a date completed graphic 56 may be displayed in order to alert or remind supervisors and/or task performers of an approaching deadline.

System 10 may also be configured for interaction between divisions of a company, or even company wide. For example, for an employee move of an employee from one division to another, system 10 may be configured to coordinate aspects of the move for both the division from which the employee is leaving and the division to which the employee is being transferred. Therefore, in some embodiments, system 10 may be configured for managing task requests and task completion of employee setup relating to employee transfers. In such embodiments, system 10 may be configured for managing task requests and task completion for both a division from which the employee is being transferred and the division to which the employee is being transferred. Initiation of the transfer request may be made by task requesters in either or both of the divisions. Exemplary manageable aspects at the division to which the employee is being transferred may include, as discussed above, such tasks as ordering furniture, delivering furniture, setting up a computer, etc. Exemplary manageable aspects at the division from which the employee is leaving may include such tasks as furniture and/or computer surplus, cancellation/closing of various accounts and/or security access, retrieval of division-specific equipment, etc. Although this disclosure primarily discusses system 10 in the context of setting up an employee or transferring an employee, system 10 could be used for management of any administrative tasks. As such, system 10 could be used, in some embodiments, simply for management of an employee's departure (e.g., upon transfer, termination, or resignation).

System 10 may be configured to allow other persons (e.g., supervisors) interested in monitoring the progress of completion of the tasks and/or setup scheme to view/track the progress of the various tasks. In some embodiments, system 10 may be a company-wide system, which may be configured to permit high-ranking corporate executives (e.g., executives that oversee more than one division) to track setup data (e.g., progress, efficiency statistics, etc.). In addition, access to system 10 may be available at a central hub, such as a human resources division. Human resources personnel may be able to enter select information, such as employee biographical information or, alternatively, such personnel may be permitted full access to initiate employee moves, particularly for setup of newly hired employees.

FIGS. 7-11 illustrate, in an exemplary fashion, at least some of the data that may be monitored and observed using system 10. By selecting a “Reports and Analysis” button 57, various data monitoring interfaces may be pulled up to display retrieved data. One or more of these data monitoring interfaces of system 10 may include an input for selecting a period of time from which data will be displayed. For example, as shown in each of FIGS. 7-11, system 10 may include a sliding scale 58 to enable such user input. Sliding scale 58 may include two slidable pointers 60. By adjusting the location of the pointers 60, a user may vary the date range from which the data will be displayed below. Alternatively, other date selection tools may be utilized, such as drop down menus (not shown).

FIG. 7 illustrates an exemplary display shown by input interface 20 that may be configured to show the average number of days that it took to complete employee setup for various types of employees. For example, a graphic, such as a ball 62, may indicate that during a selected period of time (e.g., August 2005 through July 2006, as illustrated by sliding scale 58), on average, the number of days (for example, 28 days as illustrated in FIG. 7) that it took for employee setup of employees coming into the company to be completed. A ball 64 may indicate the average number of days (for example, 32 days as illustrated in FIG. 7) that it took for employee setup of division transfers. Data for various other types of employee setups may also be displayed, such as, for example, section or work location changes (ball 66), separations (ball 68), retirements (ball 70), reclassification (ball 72), change of desk location (ball 74), etc.

In addition, as shown in FIG. 7, the average amount of lead time provided to the task performers by the task requesters may also be indicated by, for example, a bar graph. The bars of the bar graph may be associated, graphically, with the balls described above. For example, a bar 76 may be underneath ball 62 and may represent the average amount of lead time given to task performers for setup of incoming new employees (for example, 10 days as illustrated in FIG. 7). Monitoring the lead time given to task performers may enable identification of situations where task requesters are not giving task performers enough lead time to complete their tasks. For example, if an organization allots 15 days for employee setup of new employees, and a new employee is scheduled to begin work on June 30, then task requests should be initiated and sent to the appropriate task performers by June 15 in order to leave them enough time to perform their tasks.

Although different lead time may be allotted for various tasks and with different organizations as illustrated in FIGS. 7-11, system 10 may allot 15 days to perform setup tasks. Tasks that are not completed within the 15 days may be treated as overdue, which may prompt different classification, display, and/or notifications related to data associated with such overdue tasks. The allotted time for completing tasks may, in some embodiments, be customizable.

System 10 may also distinguish between “pre” and “post” tasks, as defined above. In the example illustrated in FIGS. 7-11, a period of 15 days prior to the employee's start date may be allotted for “pre” tasks, and a period of 15 days after the employee's start date may be allotted for “post” tasks. Therefore, “post” task performers may be, effectively, allotted 30 days to perform their tasks, unless their task involves subtasks that can only be performed after an employee begins work (e.g., training), in which case the “post” task performers would only have a window of 15 days to complete their task. The balls illustrating the average number of days taken to complete tasks may represent the number of days taken to complete “pre” tasks, “post” tasks, or both. For example, as shown in FIG. 7, the balls may illustrate the total number of days taken to complete all tasks, including both “pre” and “post” tasks.

The balls and/or bars in FIGS. 7-11 may vary in color based on the values they represent. For example, balls representing average days pending within the allotted 30 days and/or bars representing average lead times that are greater than the allotted 15 days may be displayed in green. In contrast, balls representing average days pending higher than the allotted 30 days and/or bars representing average lead times that are shorter than the allotted 15 days may be displayed in red (note differing cross-hatching of balls and differing cross-hatching of bars in FIGS. 7-11).

By clicking on the individual balls, more data may be viewed regarding the category of information that the balls represent. For example, by clicking on ball 62, more data regarding incoming employees may be retrieved. FIG. 8 illustrates an exemplary display that may be viewed by clicking on ball 62 shown in FIG. 7. FIG. 8 illustrates exemplary data regarding employee setup of various types of newly-hired employees (i.e., employees designated as “IN” in FIG. 7). For example, FIG. 8 illustrates a ball 78, which may display the average number of days taken to setup a typical company employee. A ball 80 may display the average number of days taken to setup a contract worker.

As in FIG. 7, the display shown in FIG. 8 may include bars indicating the average amount of lead time provided by task requestors. In addition, data may be displayed regarding setup of various other types of employees. For example, a ball 82 and/or a bar 84 may, respectively, illustrate the average days taken for setup and the lead time provided for setup of newly-hired employees in a “purchase service” division of a company. In addition, a ball 86 and/or a bar 88 may illustrate the same type of data for setup of interns, and a ball 90 and/or a bar 92 may illustrate the same type of data for setup of newly-hired employees who are involved in a rotational work/training program (e.g., a program in which the employees frequently move from job to job within a company over a period of time, to learn about multiple aspects of the company's business).

As in FIG. 7, by clicking on individual balls in FIG. 8, additional data about the associated category may be retrieved. It should be noted that in any of the displays shown in FIGS. 7-11, more data may be retrieved by clicking on one or more graphics in the interface. For example, not only may more data be retrieved by clicking on the balls but, in some embodiments, more data may be retrieved by clicking on the bars.

FIG. 9 illustrates an interface displaying exemplary data for one of the categories displayed in FIG. 8. In particular, the balls and bars in FIG. 9 may illustrate, respectively, the actual time taken to complete the setup and the lead time given for setup of individual employees within a category selected from those displayed in FIG. 8 (e.g., regular ACME CO. employees, as shown in FIG. 9, which may be retrieved by clicking on ball 78 illustrated in FIG. 8). It should also be noted that in FIG. 9 pointers 60 of sliding scale 58 have been adjusted to retrieve data only for individuals for which setup was requested and/or performed during the month of May.

FIG. 10 illustrates a display of exemplary data for one of the employees displayed in FIG. 9. In particular, FIG. 10 illustrates the actual time taken by several different task performers or groups of task performers to complete their respective tasks as part of the setup for Fred White. For example, a ball 94 illustrates that a “machine assignment” was completed in zero days (i.e., complete the same day it was requested), and a ball 96 illustrates that the accounting task performer or performers took 30 days to complete the requested accounting tasks. FIG. 10 also illustrates a selectable toggle 98 between “pre” tasks and “post” tasks. Such a toggle may also be featured in one or more of the other displays shown in FIGS. 7-11.

FIG. 11 illustrates a display of exemplary data for one of the task performers or groups of task performers displayed in FIG. 10. In particular, FIG. 11 illustrates the actual time taken to complete various subtasks performed by the accounting task performer or performers.

### INDUSTRIAL APPLICABILITY

The disclosed system may be applicable to managing setup of employees for various aspects of their employment. Managing employee setup may include, for example, initiating, organizing, and/or monitoring of the setup process. The disclosed system may be applicable to managing setup of newly hired employees, as well as employees who are transferring from one division to another within a company, and even employees who are moving to a new workspace within the same division. The disclosed system may also be applicable to managing setup of temporary, rotating, contracted, and other types of employees. For any of these and other employee setup procedures, there are numerous tasks to be coordinated and performed in order to situate the employee and enable them to begin working. The disclosed system may facilitate completion of these tasks in an efficient and timely manner, such that the employee has all the resources available to them at the appropriate time (e.g., when the employee begins working at their new workspace).

The disclosed system may be applicable to setting up various types of resources at an employee's workspace, which may include, for example, office furniture, such as a desk, chair, filing cabinet, etc., as well as equipment, such as a computer, telephone, etc. The disclosed system may also be applicable to setting up certain accounts and/or services, such as security authorizations/access keys and/or codes, ID badges, computer accounts, email accounts, telephone, cell phone, etc., as well as addition/removal of the employee's name to/from various distribution lists.

The disclosed system may be applicable to management of certain training that may be appropriate and/or necessary for the employee given the position they will hold upon beginning work in the new workspace. In some cases, particular training may even be required by law. The disclosed system may be configured to automatically facilitate arrangement and/or management of training for an employee. For example, one or more tasks or subtasks may include arrangement and/or management of training within one or more setup schemes.

The disclosed system may also be applicable to managing additional setup tasks associated with special needs of an employee. Such special needs may include, for example, handicap access, TTL (phone accommodation for the hearing impaired), etc.

In some embodiments, the disclosed system may be configured to display business data, to various users, regarding completion of employee setup. Access to such data may be restricted. For example, certain data may only be viewed by persons in managerial, supervisory, and/or executive positions. Monitoring such data may enable such persons to observe timeliness and/or efficiency of the task performers, divisions, and/or the company as a whole with regard to performance of employee setup. Monitoring such data may enable good and/or poor performing employees to be identified. In addition, the monitoring capabilities of the disclosed system may enable identification of various “bottlenecks” (e.g., various tasks or task performers that seem to take a long time and tend to hold up the overall progress of a setup scheme). By enabling identification of problems, such as bottlenecks, the disclosed system may facilitate improvements in speed and/or efficiency, as measures may be taken to address the identified problems and find solutions.

It will be apparent to those having ordinary skill in the art that various modifications and variations can be made to the disclosed employee setup management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents

What is claimed is:

1. A computer-readable medium having stored thereon instructions for tracking tasks related to a method for an employee setup, comprising:
collecting input related to setup of an employee including one or more task requests for performance of one or more tasks involved in employee setup;
directing information related to the one or more task requests to task performers;
collecting input from the task performers related to the progress of completion of the requested tasks; and
displaying information related to the progress of completion of the requested tasks, wherein the displayed information indicates one of a plurality of incremental levels of completion.

2. The computer-readable medium of claim 1, wherein the plurality of incremental levels of completion includes percentages of completion.

3. The computer-readable medium of claim 1, wherein the one or more tasks are part of a task group including more than one task related to an employee setup process.

4. The computer-readable medium of claim 3, wherein the method further includes:
collecting input from the task performers related to the progress of completion of the requested tasks; and
displaying information related to the progress of completion of the task group, based on the collected input from the task performers.

5. The computer-readable medium of claim 1, wherein the method includes managing task requests and task completion relating to an employee transfer setup.

6. The computer-readable medium of claim 5, wherein the method includes managing task requests and task completion for both a division from which the employee is being transferred and the division to which the employee is being transferred.

7. The computer-readable medium of claim 1, wherein the method includes:
collecting input from the task performers to thereby define subtasks involved in completing the requested tasks; and
associating the subtasks with subsequent requests for the same tasks.

8. A method for an employee setup, comprising:
collecting input related to setup of an employee including one or more task requests for performance of one or more tasks involved in employee setup;
directing information related to the one or more task requests to task performers;
collecting input from the task performers related to the progress of completion of the requested tasks; and
displaying information related to the progress of completion of the requested tasks, wherein the displayed information indicates one of a plurality of incremental levels of completion.

9. The method of claim 8, wherein the plurality of incremental levels of completion includes percentages of completion.

10. The method of claim 8, wherein the one or more tasks are part of a-task group including more than one task related to an employee setup process.

11. The method of claim 10, wherein the method further includes:
collecting input from the task performers related to the progress of completion of the requested tasks; and
displaying information related to the progress of completion of the task group, based on the collected input from the task performers.

12. The method of claim 8, wherein the method includes managing task requests and task completion relating to an employee transfer setup.

13. The method of claim 12, wherein the method includes managing task requests and task completion for both a division from which the employee is being transferred and the division to which the employee is being transferred.

14. An employee setup management system, comprising:
a display device configured to display information;
an input device configured to accept input related to setup of an employee including one or more task requests for performance of one or more tasks involved in employee setup;
a processor configured to process accepted setup information; and
a computer-readable medium operatively coupled to the processor and having stored thereon instructions for performing a method for employee setup including:
collecting input related to setup of an employee including one or more task requests for performance of one or more tasks involved in employee setup;
directing information related to the one or more task requests to task performers;
collecting input from the task performers related to the progress of completion of the requested tasks; and
displaying information related to the progress of completion of the requested tasks, wherein the displayed information indicates one of a plurality of incremental levels of completion.

15. The system of claim 14, wherein the plurality of incremental levels of completion includes percentages of completion.

16. The system of claim 14, wherein the one or more tasks are part of a task group including more than one task related to an employee setup process.

17. The system of claim 16, wherein the method further includes:
collecting input from the task performers related to the progress of completion of the requested tasks; and
displaying information related to the progress of completion of the task group, based on the collected input from the task performers.

18. The system of claim 14, wherein the method includes managing task requests and task completion relating to an employee transfer setup.

19. The system of claim 18, wherein the method includes managing task requests and task completion for both a division from which the employee is being transferred and the division to which the employee is being transferred.

20. The system of claim 14, wherein the method includes:
collecting input from the task performers to thereby define subtasks involved in completing the requested tasks; and
associating the subtasks with subsequent requests for the same tasks.
